(19) United States
(12) Patent Application Publication
(10) Pub. No.: US 2021/0215505 A1
(43) Pub. Date: Jul. 15, 2021

(54) VEHICLE SENSOR CALIBRATION

(71) Applicant: Ford Global Technologies, LLC, Dearborn, MI (US)

(72) Inventors: Juan Enrique Castorena Martinez, Southfield, MI (US); Krishanth Krishnan, Windsor (CA); Yucong Lin, Canton, MI (US); Gintaras Vincent Puskorius, Novi, MI (US)

(73) Assignee: Ford Global Technologies, LLC, Dearborn, MI (US)

(21) Appl. No.: 16/740,705

(22) Filed: Jan. 13, 2020

(51) Int. Cl. G01C 25/00; G01C 21/16

(52) U.S. Cl. CPC G01C 25/005; G01C 21/165

(57) ABSTRACT

A computer, including a processor and a memory, the memory including instructions to be executed by the processor to receive initialization data for vehicle sensors including a first sensor, a second sensor and a third sensor, wherein the first sensor and the second sensor are a same type of sensor, and wherein initialization data is measurement of a common location on a fiducial target, determine a common coordinate system by a pair-wise evaluation of the initialization data between the first and second sensors, acquire first, second, and third sensor data from the first, second, and third sensors respectively and translate first, second, and third sensor data into the common coordinate system. The instructions can further include instructions to determine errors in the first, second and third sensor data based on the common coordinate system, determine a transformation to correct the errors, calibrate one or more of the first, second, and third sensors with respect to the common coordinate system based on the determined transformation to remove the errors and operate a vehicle based on first, second, and third sensors data acquired by calibrated first, second and third sensors.

### BACKGROUND

Vehicles can be equipped with computing devices, networks, sensors and controllers to acquire information regarding the vehicle's environment and to operate the vehicle based on the information. Vehicle sensors can provide data concerning routes to be traveled and objects to be avoided in the vehicle's environment. Operation of the vehicle can rely upon acquiring accurate and timely information regarding objects in a vehicle's environment while the vehicle is being operated on a roadway.

### BRIEF DESCRIPTION OF THE DRAWINGS

FIG. 1 is a block diagram of an example traffic infrastructure system.

FIG. 2 is a diagram of an example vehicle including sensors.

FIG. 3 is a diagram of example sensor fields of view.

FIG. 4 is a diagram of an example fiducial.

FIG. 5 is a flowchart diagram of an example process to calibrate vehicle sensors and operate a vehicle.

### DETAILED DESCRIPTION

Vehicles can be equipped to operate in both autonomous and occupant piloted mode. By a semi- or fully-autonomous mode, we mean a mode of operation wherein a vehicle can be piloted partly or entirely by a computing device as part of an information system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering. In a non-autonomous vehicle, none of these are controlled by a computer.

A computing device in a vehicle can be programmed to acquire data regarding the external environment of a vehicle and to use the data to determine a vehicle path upon which to operate a vehicle in autonomous or semi-autonomous mode. A vehicle can operate on a roadway based on a vehicle path by determining commands to direct the vehicle's powertrain, braking, and steering components to operate the vehicle to travel along the path. The data regarding the external environment can include the location of one or more moving objects such as vehicles and pedestrians, etc., in an environment around a vehicle and can be used by a computing device in the vehicle to operate the vehicle.

Operating the vehicle based on acquiring data regarding the external environment can depend upon acquiring the data using vehicle sensors. Vehicle sensors can include lidar sensors, radar sensors, and video sensors operating at one or more of visible light or infrared light frequency ranges. Vehicle sensor can also include one or more of a global positioning system (GPS), an inertial measurement unit (IMU) and wheel encoders. Acquiring accurate data regarding an environment around a vehicle using vehicle sensors can depend upon accurately calibrating the vehicle sensors to ensure that the acquired data can be accurately combined. Calibrating the vehicle sensors means that data from each sensor is compared to an independently determined measurement, for example an external target with ground truth data regarding the locations and size of the target measured by a human operator or, as discussed herein, one or more measurements of objects located in an environment around a vehicle measured by one or more other sensors and can include converting the data from each vehicle sensor into global coordinates. In this fashion data regarding objects viewed by two or more calibrated sensors can be accurately combined as the same object, for example. Objects viewed by the vehicle sensors can include other vehicles and pedestrians, for example.

Disclosed herein is method including receiving initialization data for vehicle sensors including a first sensor, a second sensor and a third sensor, wherein the first sensor and the second sensor are a same type of sensor, and wherein initialization data is measurement of a common location on a fiducial target, determining a common coordinate system by a pair-wise evaluation of the initialization data between the first and second sensors and acquiring first, second, and third sensor data from the first, second, and third sensors respectively. The first, second, and third sensor data can be translated into the common coordinate system, errors in the first, second and third sensor data can be determined based on the common coordinate system and a transformation can be determined to correct the errors. One or more of the first, second, and third sensors can be calibrated with respect to the common coordinate system based on the determined transformation to remove the errors and a vehicle can be operated based on first, second, and third sensor data acquired by calibrated first, second and third sensors. Pair-wise evaluation of initialization data can include comparing the initialization data between one or more of the first and second sensors, the first and third sensors, and the second and third sensors.

Determining initialization data can be based on one or more of a global positioning system (GPS), an inertial measurement unit (IMU), and wheel encoders. Determining the common coordinate system can be based on acquiring sensor data that includes detecting a fiducial target in each of first and second sensor initialization data. Determining the common coordinate system can be based on third sensor initialization data by determining a location of fiducial data in the third sensor initialization data. A common feature in the first, second and third sensor data can be determined, wherein the common feature can be determined by locating an object in an environment around a vehicle with machine vision techniques. The error can be determined by comparing the locations of the object in each of the first, second, and third sensor data. The transformation can be determined based on minimizing the errors between the locations of the object in first, second, and third sensor data. The transformation can be updated and the first, second, and third sensors can be re-calibrated periodically as the vehicle is operated. The transformation can include translations in x, y, and z linear coordinates and rotations in roll, pitch, and yaw angular coordinates. The common coordinate system can be determined based on determining physical alignment data and data regarding fields of view of the first and second sensors. The transformations can minimize six-axis errors between first and second sensors. Operating the vehicle can be based on locating one or more objects in first, second and third sensor data. Determining errors in the first, second and third sensor data can include first decoupling the orientation and translation.

Further disclosed is a computer readable medium, storing program instructions for executing some or all of the above method steps. Further disclosed is a computer programmed for executing some or all of the above method steps, including a computer apparatus, programmed to receive initialization data for vehicle sensors including a first sensor, a second sensor and a third sensor, wherein the first sensor and the second sensor are a same type of sensor, and wherein initialization data is measurement of a common location on a fiducial target, determine a common coordinate system by a pair-wise evaluation of the initialization data between the first and second sensors and acquire first, second, and third sensor data from the first, second, and third sensors respectively. The first, second, and third sensor data can be translated into the common coordinate system, errors in the first, second and third sensor data can be determined based on the common coordinate system and a transformation can be determined to correct the errors. One or more of the first, second, and third sensors can be calibrated with respect to the common coordinate system based on the determined transformation to remove the errors and a vehicle can be operated based on first, second, and third sensor data acquired by calibrated first, second and third sensors. Pair-wise evaluation of initialization data can include comparing the initialization data between one or more of the first and second sensors, the first and third sensors, and the second and third sensors.

The computer can be further programmed to determine initialization data can be based on one or more of a global positioning system (GPS), an inertial measurement unit (IMU), and wheel encoders. Determining the common coordinate system can be based on acquiring sensor data that includes detecting a fiducial target in each of first and second sensor initialization data. Determining the common coordinate system can be based on third sensor initialization data by determining a location of fiducial data in the third sensor initialization data. A common feature in the first, second and third sensor data can be determined, wherein the common feature can be determined by locating an object in an environment around a vehicle with machine vision techniques. The error can be determined by comparing the locations of the object in each of the first, second, and third sensor data. The transformation can be determined based on minimizing the errors between the locations of the object in first, second, and third sensor data. The transformation can be updated and the first, second, and third sensors can be re-calibrated periodically as the vehicle is operated. The transformation can include translations in x, y, and z linear coordinates and rotations in roll, pitch, and yaw angular coordinates. The common coordinate system can be determined based on determining physical alignment data and data regarding fields of view of the first and second sensors. The transformations can minimize six-axis errors between first and second sensors. Determining errors in the first, second and third sensor data can include first decoupling the orientation and translation.

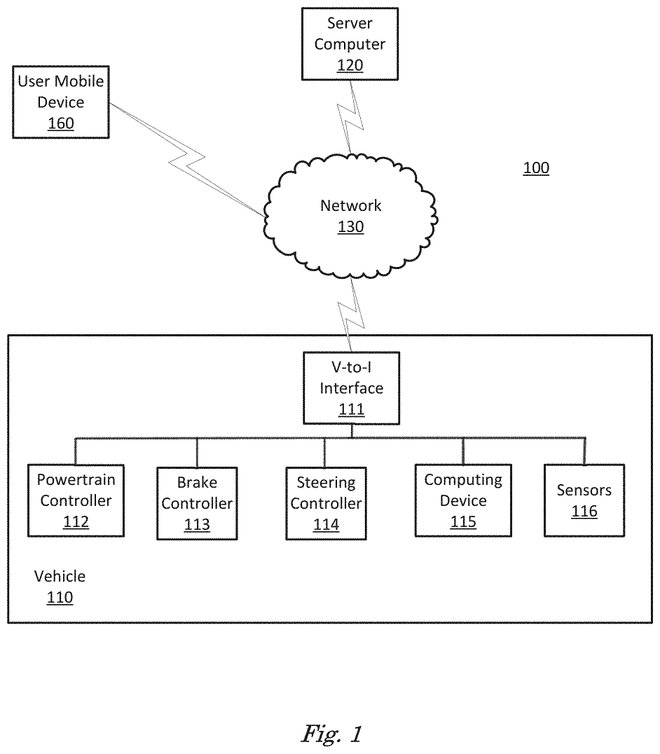

FIG. 1 is a diagram of a traffic infrastructure system 100 that includes a vehicle 110 operable in autonomous (“autonomous” by itself in this disclosure means “fully autonomous”), semi-autonomous, and occupant piloted (also referred to as non-autonomous) mode. One or more vehicle 110 computing devices 115 can receive information regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing device, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (Wi-Fi) or cellular networks. The computing device 115 may be configured for communicating through a vehicle-to-infrastructure (V-to-I) interface 111 with a remote server computer 120 via an edge computing device, where an edge computing device is defined as a computing device configured to be in communication with sensors and vehicles 110 local to a portion of a roadway, parking lot or parking structure, etc. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

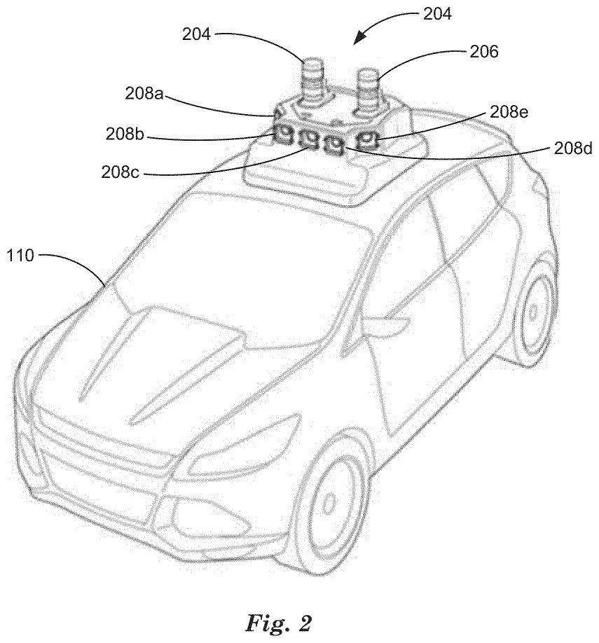

FIG. 2 is a diagram of an example vehicle 110 equipped with a sensor housing 202. Sensor housing 202 attaches to the top of vehicle 110 and includes lidar sensors 204, 206 and video sensors 208a, 208b, 208c, 208d, 208e (collectively video sensors 208). Lidar sensors 204, 206 and video sensors 208 can also be distributed around the vehicle 110, for example, and included as part of headlamp or taillamp housings where the lidar sensors 204, 206 and video sensors 208 can be at least partially hidden from view. Lidar sensors 204, 206 and video sensors 208 can be used by a computing device 115 in a vehicle 110 to determine data regarding an environment around a vehicle 110. For example, lidar sensors 204, 206 and video sensors 208 can be used to determine objects in an environment around a vehicle 110. Objects in an environment around a vehicle 110 can include other vehicles and pedestrians, for example. As discussed above, combining sensor data from two or more sensors, also called sensor fusion, where the sensors can be different of modalities, i.e., a sensor modality specifies a medium via which a sensor obtains data, i.e., sensors of different modalities sense data via different respective media, e.g., lidar uses laser beams, cameras detect (visible, infrared, etc.) light, radar uses radio frequency transmissions, etc., can improve the ability to accurately identify and locate objects in an environment around a vehicle. Each sensor modality has different strengths that complement other modalities when combined. For example, video sensors, both visible and infrared, have high spatial resolution but cannot directly measure distance. Lidar sensors can directly measure distance to objects with high resolution but generally have lower spatial resolution than video sensors. Radar sensors measure object motion very accurately but can have low absolute distance and spatial resolution. Combining sensor data from different modalities can yield data that is more accurate regarding the location, size and movement of objects than any of the modalities alone.

Combining sensor data from sensors of different modalities can be enabled by first converting the data from each sensor into a common coordinate system. A common coordinate system can be based on a global coordinate system such as latitude, longitude and altitude, where six-axis DoF data can be expressed as translations in x, y, and z linear coordinates and rotations in roll, pitch, and yaw angular coordinates with respect to the x, y, and z axes respectively, where the x, y, and z axes are defined with respect to the earth's surface. Lidar and video sensors are calibrated with respect to a common coordinate system, where the common coordinate system is defined with respect to a location on the vehicle 110, instead of a global coordinate system because they are mounted on a moving vehicle 110 that is in motion with respect to the global coordinate system. To transform sensor data into a common coordinate system, the sensor can be first aligned, where alignment refers to mechanically arranging the sensor with respect to the platform. Mounting lidar and video sensors 204, 206, 208 in a sensor housing 202 can permit initial mechanical alignment of lidar and video sensors 204, 206, 208 prior to the housing 202 being mounted on the vehicle 110. In examples where the lidar and video sensors 204, 206, 208 are mounted in a distributed fashion on the vehicle 110 as discussed above the lidar and video sensors 204, 206, 208 can be initially mechanically aligned following mounting on the vehicle 110.

Following initial mechanical alignment, sensors can be calibrated, where calibration is defined as determining where a sensor field of view is located with respect to a common coordinate system. In spite of initial mechanical alignment of lidar and video sensors 204, 206, 208, differences in six-axis degree of freedom (DoF) alignment of lidar and video sensors 204, 206, 208 can require that lidar and video sensors 204, 206, 208 be calibrated to permit sensor data to be combined in a common coordinate system. In addition, normal misalignment due to wear, vibration and drift in sensor components can require that lidar and video sensors 204, 206, 208 be re-aligned periodically to ensure accurate sensor fusion. Techniques described herein improve multi-modal sensor calibration and re-calibration in a common coordinate system by determining errors between pairs of sensors and determining transformations that calibrate sensors on the fly while a vehicle 110 is operating without operator intervention or the use of external fiducial markers, referred to herein as fiducial targets. Errors are defined as differences in measured locations of objects including fiducial targets in sensor data acquired by two or more sensors.

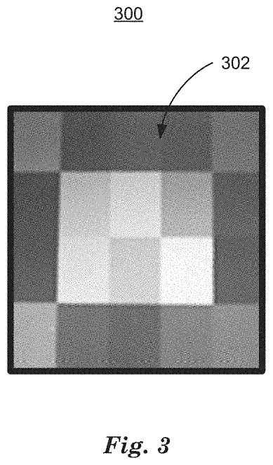

FIG. 3 is a diagram of an example fiducial target 300. Fiducial target 300 is a flat object with a pattern of squares 302 of differing reflectance values applied to a surface of the fiducial target 300. A fiducial target 300 can be used for initial calibration of lidar and video sensors 204, 206, 208 by placing the fiducial target 300 at a measured location in the fields of view of lidar and video sensors 204, 206, 208. Each of the lidar and video sensors 204, 206, 208 can form images of the fiducial target 300 and determine a location of the fiducial target 300 with respect to a field of view of each of the lidar and video sensors 204, 206, 208 using machine vision techniques. For example, machine vision techniques can differentiate the video images with respect to x and y image axes and then locate the borders between the squares 302 with sub-pixel accuracy. Likewise, machine vision techniques can be applied to lidar images to determine the location of the top, bottom, left, and right edges of the fiducial target 300 to sub-pixel accuracy. Other features of the fiducial target 300 that can be measured in lidar or video data using machine vision techniques include corners, centers of edges, and the center of the fiducial target 300. The location of the fiducial target 300 in pixels for each image can be compared to the measured location of the fiducial target 300 with respect to a location on the vehicle 110 and a transformation can be determined that converts pixel locations in acquired images of each of the lidar and video sensors 204, 206, 208 into common coordinates with respect the vehicle 110.

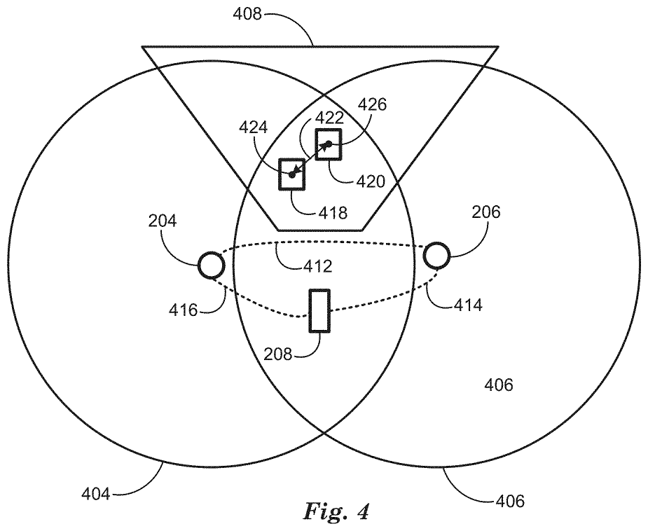

FIG. 4 is a diagram of fields of view 404, 406, 408 corresponding to lidar sensors 204, 206 and a video sensor 208, respectively. Lidar sensors 204, 206 can acquire data regarding objects in their respective fields of view 404, 406 according to machine vision techniques as discussed above in relation to FIG. 3 to determine a center of mass with respect to the points determined to correspond to the object. In FIG. 4 a first object 418 corresponds to the object imaged by lidar sensor 204 and converted from coordinates measured relative to the lidar sensor 204 into common coordinates and a second object 420 corresponds to the object imaged by lidar sensor 206 and converted from coordinates measured relative to the lidar sensor 206 into common coordinates. The first and second objects 418, 420 do not occupy the same position in common coordinates due to calibration errors between the two lidar sensors 204, 206. The error 422 illustrated by the arrow in FIG. 4 corresponds to the difference in common coordinates between the determined centers of mass D₁L₁ 424 and D₂L₁ 426 corresponding to the lidar sensor 204 and lidar sensor 206 respectively.

Techniques described herein determines a transformation {R_{L}_{₁}^{L}^{₂}, t_{L}_{₁}^{L}^{₂}} that minimizes the rotational (R) and translational (t) six-axis error or offset between the first (L₁) and second (L₂) lidar sensors 204, 206 by pair-wise comparison of measurements from (L₁) and second (L₂) lidar sensors 204, 206. Pair-wise comparison compares data from two selected sensors at a time, without regard to measurements from other non-selected sensors. Techniques discussed herein calculate pair-wise evaluations of two or more pairs of sensors and then combines the pair-wise evaluations to determine calibration for each sensor. The six-axis error can be determined by comparing two or more common features on a fiducial target 300 in three-dimensional space expressed in common coordinates and measured by both the first (L₁) and second (L₂) lidar sensors 204, 206. Comparing measured locations of two or more common points in space permits calculation of rotational (R) and translational (t) six-axis error. A common feature on a fiducial target 300 is a location on a fiducial target 300 that can be identified by two or more sensors, for example corners, centers of edges, or the center of the fiducial target 300. The technique then updates transformations {R_{C}_{₁}^{L}^{₁}, t_{C}_{₁}^{L}^{₁}} and {R_{L}_{₂}^{C}^{₁}, t_{L}_{₂}^{C}^{₁}} that characterize the six-axis error of offset between each lidar sensor 204, 206 and the video sensor 208 (C₁). The initial estimates for {R_{C}_{₁}^{L}^{₁}, t_{C}_{₁}^{L}^{₁}} and {R_{L}_{₂}^{C}^{₁}, t_{L}_{₂}^{C}^{₁}} can be obtained from initial calibration data based on imaging a fiducial target 300 as described above in relation to FIG. 3 above, or any other suitable known technique for initial calibration. For example, initial estimates for {R_{C}_{₁}^{L}^{₁}, t_{C}_{₁}^{L}^{₁}} and {R_{L}_{₂}^{C}^{₁}, t_{L}_{₂}^{C}^{₁}} can be determined based on pair-wise evaluation of alignment data for the video sensor 208 (C₁) and lidar sensors 204, 206 obtained by acquiring sensor data for common locations on a fiducial target 300. Initial alignment data for video sensor 208 (C₁) and lidar sensors 204, 206 determined based on acquiring data from a fiducial target 300 will provide alignment data that permits techniques described herein to perform calibration of the three sensors at times subsequent to the initial calibration, for example while a vehicle 110 is being operated on a roadway and access to a fiducial target 300 would be unfeasible.

In FIG. 3, a fiducial target 300 is placed in the scene such that the overlapping fields of view 404, 406, 408 include the target. Data from the scene is then collected and used as input to an optimization process which determines the extrinsic parameters that minimize the distances between features extracted from the camera image of the target and features extracted from the re-projection of lidar points. This initialization is performed twice based on the number of pairs of multi-modal combinations: one to initialize {R_{C}_{₁}^{L}^{₁}^{⁰}, t_{C}_{₁}^{L}^{₁}^{⁰}} and the other for {R_{L}_{₂}^{C}^{₁}^{⁰}, t_{L}_{₂}^{C}^{₁}^{⁰}} (i.e., to initialize a relative position between C₁, L₁ and L₂,C₁, respectively). Here, we define the superscript ⁰ to indicate an initial estimate whereas the more generic superscript ^{t} is an index that indicates measurements or estimates at time instant t. Given the relative positions between lidar sensor 204, 206 pairs we can initialize the relative position {R_{L}_{₁}^{L}^{₂}^{⁰}, t_{L}_{₁}^{L}^{₁}^{⁰}} between lidar sensors 204 206 L₁ and L₂ by determining cycle consistency which is based on the relationships

R_{L}_{₁}^{L}^{₂}^{⁰}=(R_{C}_{₁}^{L}^{₁}^{⁰}·R_{L}_{₂}^{C}^{₁}^{⁰})^{T} (1)

t_{C}_{₁}^{L}^{₁}^{⁰}=−(R_{L}_{₁}^{L}^{₂}^{⁰}t_{C}_{₁}^{L}^{₁}^{⁰}+(R_{L}_{₂}^{C}^{₁}^{⁰})^{T}t_{L}_{₂}^{C}^{₁}^{⁰}) (2)

Once all of the pair-wise relative position combinations have been initialized, a computing device 115 in a vehicle 110 can begin sensing the environment and acquiring lidar data on the fly from the perspective of each lidar sensor 204, 206 independently. Note that this technique is not limited to a vehicle 110 and can be applied to any mobile platform equipped with multi-modal sensors including drones, boats, etc. As new lidar data becomes available this technique takes the new lidar data and learns a better estimate of extrinsic calibration parameters by minimizing error or mis-alignment between the new lidar data and previous estimates of the calibration parameters. Assessment of error or mis-alignment is done by comparing distances between corresponding detections where correspondence is simplified to be computed through nearest neighbor associations. This association is valid provided our initialization estimates or previous estimates are good enough to bring data from the sensors close to but not into exact alignment.

Mathematically, the problem of online learning extrinsic calibration parameters based on corrections to errors, or mis-alignments of sensor fields of view and previous estimates of the parameters is formalized as:

$$\{ {R}_{{L}_{1}}^{{{L}_{2}}^{0}} , {t}_{{L}_{1}}^{{{L}_{2}}^{0}} \} = \begin{matrix}arg min \\ \{ R , t \} ϵ SE ( 3 )\end{matrix} \{ f ( \{ {R}_{{L}_{1}}^{{{L}_{2}}^{t - 1}} , {t}_{{L}_{1}}^{{{L}_{2}}^{t - 1}} \} , \{ R , t \} ) + {λ}_{1} {Δ}_{F} ( R , {R}_{{L}_{1}}^{{{L}_{2}}^{t - 1}} ) + {λ}_{2} {‖ {t}_{{L}_{1}}^{{{L}_{2}}^{t - 1}} - t ‖}_{{ℓ}_{2}}^{2} \} \qquad ( 3 )$$

Here, the first term is measuring error or mis-alignment through sum of distances between object detection representations, while the second and third terms Δ_{F}: {SO(3), SO(3)}→ [symbol] ⁺ and ∥· [symbol] : [symbol] → [symbol] ⁺ constrain updates to R and t, respectively, to vary smoothly from its previous estimates, where SO(3) denotes a special orthogonal group in three dimensions that corresponds to rotations in three space. The first term measuring error of miss-alignment can be described as:

$$f ( \{ {R}_{{L}_{1}}^{{{L}_{2}}^{t - 1}} , {t}_{{L}_{1}}^{{{L}_{2}}^{t - 1}} \} , \{ R , t \} ) = {\sum }_{l = 1}^{L} {\sum }_{k = 1}^{K} {‖ {{y}_{1}}_{l , k}^{t} ( \{ {R}_{{L}_{1}}^{{{L}_{2}}^{t - 1}} , {t}_{{L}_{1}}^{{{L}_{2}}^{t - 1}} \} , \{ R , t \} ) - {{y}_{2}}_{l , k}^{t} ‖}_{{ℓ}_{2}}^{2} \qquad ( 4 )$$

where the terms y₁_{_{l,k}}^{t} and y₂_{_{l,k}}^{t} are the corresponding object detections signature representations from L₁ and L₂ at time instant t, respectively. The value K denotes a detection representation: if K=1 then a center of mass representation of detections is used, whereas K>1 denotes a labeled sensor measurement representation (i.e., an object is represented by K labeled measurements). The summation over l represents the number of objects detected with l indexing a specific object and L being the total number of objects at the given time instant t. The second term Δ_{F} constrains rotation updates R to be confined within a smooth space by von Neumann divergence:

Δ_{F}(R,R_{L}_{₁}^{L}^{₂}^{^{t−1}})=Tr(R log R−R log R_{L}_{₁}^{L}^{₂}^{^{t−1}}−R+R_{L}_{₁}^{L}^{₂}^{^{t−1}}) (5)

This function measures the distance between two rotations and has the property of being differentiable in the manifold of SO(3). One thing to note is that log: R^{N×N}→R^{N×N} is the matrix logarithm with inverse mapping exp: R^{N×N}→R^{N×N} and Tr is the matrix trace. Further regarding equation (3), the search space is over the special Euclidean group denoted by SE(3), where SE(3) is a special Euclidian group in three dimensions and corresponds to a standard three dimensional vector space, and the scalar parameters λ₁, λ₂∈[0, 1] are weighting factors for each of the corresponding terms.

Techniques discussed herein simplify a solution to equation (3) by first decoupling the orientation and translation. This can be achieved by first centering the signature detection representations. Here, we denote the centered detection representations as y̅₁̅_{l,k}^{t} and y̅₂̅_{l,k}^{t} from L₁ and L₂, respectively, where this centering corresponds to simple averaging. Given this centered version we can simplify equation (3) by decoupling it as:

$${R}_{{L}_{1}}^{{{L}_{2}}^{t}} = \begin{matrix}arg min \\ R ∈ SO ( 3 )\end{matrix} \{ {Δ}_{F} ( R , {R}_{{L}_{1}}^{{{L}_{2}}^{t - 1}} ) + {λ}_{1} {\sum }_{l = 1}^{L} {\sum }_{k = 1}^{K} {‖ {\overline{{y}_{1}}}_{l , k}^{t} ( {R}_{{L}_{1}}^{{{L}_{2}}^{t - 1}} , R ) - {\overline{{y}_{2}}}_{l , k}^{t} ‖}_{{ℓ}_{2}}^{2} \} \qquad ( 6 )$$

$${t}_{{L}_{1}}^{{{L}_{2}}^{t}} = \begin{matrix}arg min \\ {tϵ ℝ}^{3}\end{matrix} \{ {‖ {R}_{{L}_{1}}^{{{L}_{2}}^{t}} \cdot {\overline{{y}_{1}}}_{l , k}^{t} - {\overline{{y}_{2}}}_{l , k}^{t} - t ‖}_{{ℓ}_{2}}^{t} + {λ}_{2} {‖ {t}_{{L}_{1}}^{{{L}_{2}}^{t - 1}} - t ‖}_{{ℓ}_{2}} \} \qquad ( 7 )$$

Equation (6) can be solved by an iterative algorithm to solve (6) for rotations in the Riemannian manifold R∈SO(3) that consists of matrix exponentiated gradient descent updates. The solution for equation (7) is closed and can be obtained by computing the gradient of equation (7), setting it equal to zero and then solving for t.

After updating the calibration parameters between lidar sensors L1 and L2 the update can be propagated based on the cycle consistency constraint to the calibration parameters of the remaining multi-modal combinations (i.e., L1-to-C1 and L2-to-C1), where calibration parameters are estimates of sensor error or mis-alignment. Such an update is propagated by alternating between updating {R_{C}_{₁}^{L}^{₁}^{^{t}}, t_{C}_{₁}^{L}^{₁}^{^{t}}} for time instance t and updating {R_{L}_{₂}^{C}^{₁}^{^{t+1}}, t_{L}_{₂}^{C}^{₁}^{^{t+1}}} at the next update occurring at t+1 according to equations (8) and (9):

$$\begin{matrix}\{ {R}_{{C}_{1}}^{{{L}_{1}}^{t}} , {t}_{{C}_{1}}^{{{L}_{1}}^{t}} \} = {\{ {( {R}_{{L}_{2}}^{{{C}_{1}}^{t - 1}} {R}_{{L}_{1}}^{{{L}_{2}}^{t}} )}^{T} , - {( {R}_{{L}_{1}}^{{{L}_{2}}^{t}} )}^{T} ( {( {R}_{{L}_{2}}^{{{C}_{1}}^{t - 1}} )}^{T} {t}_{{L}_{2}}^{{{C}_{1}}^{t - 1}} + {t}_{{L}_{1}}^{{{L}_{2}}^{t}} ) \}}^{at : t} & ( 8 ) \\ \{ {R}_{{L}_{2}}^{{{C}_{1}}^{t + 1}} , {t}_{{L}_{2}}^{{{C}_{1}}^{t + 1}} \} = {\{ {( {R}_{{L}_{1}}^{{{L}_{2}}^{t + 1}} {R}_{{C}_{1}}^{{{L}_{1}}^{t}} )}^{T} , - {R}_{{L}_{2}}^{{{C}_{1}}^{t + 1}} ( {R}_{{L}_{1}}^{{{L}_{2}}^{t + 1}} {t}_{{C}_{1}}^{{{L}_{1}}^{t}} + {t}_{{L}_{1}}^{{{L}_{2}}^{t + 1}} ) \}}^{at : t + 1} & ( 9 )\end{matrix}$$

Techniques described herein improve sensor calibration by handling difficulties associated to alignment of data of multiple modalities and/or multiple resolutions. Examples of these difficulties include finding features invariant to each modality and finding techniques to either down sample the modality of higher resolution or super-resolving the modality of lower resolution to make comparisons by matching sensor resolutions. Techniques describe herein use spatial and temporal data to constraint alignments which in general yields better estimates of calibration parameters. In addition, techniques described herein are capable of both doing online or real-time verification of the calibration parameters and correcting for mis-calibrations without human intervention or fiducial targets 300 placed in the scene after initial calibration. Techniques described herein are cheap from a computational standpoint and offer an algorithmic solution to mass deployment scalability and use components already available in most autonomous vehicles 110 and traffic infrastructure systems 100.

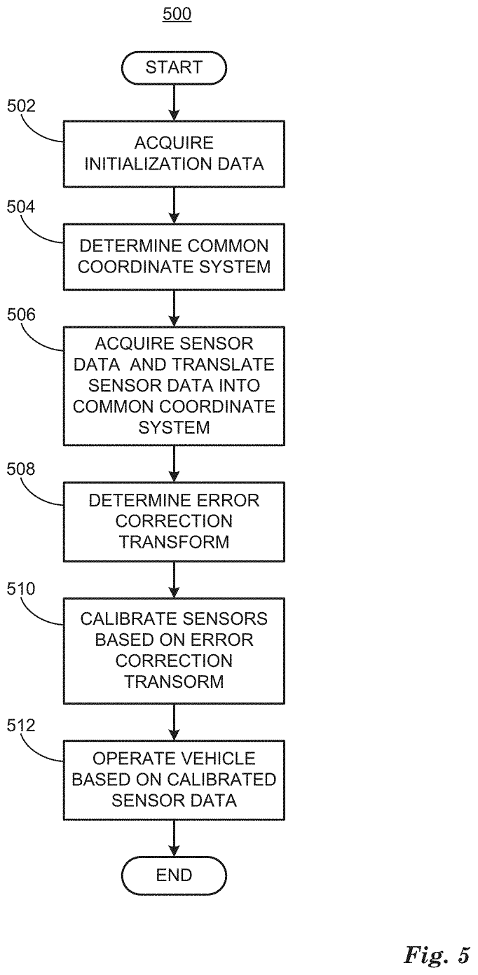

FIG. 5 is a diagram of a flowchart, described in relation to FIGS. 1-4, of a process 500 for operating a vehicle based on calibrated multi-modal sensor data. Process 500 can be implemented by a processor of computing device, taking as input information from sensors, and executing commands, and outputting object information, for example. Process 500 includes multiple blocks that can be executed in the illustrated order. Process 500 could alternatively or additionally include fewer blocks or can include the blocks executed in different orders.

Process 500 begins at block 502, where a computing device 115 acquires initial calibration data from two or more vehicle sensors, where at least two of the sensors are of the same type. Initial calibration data can be acquired to include a fiducial target 300 in the fields of view of the two or more sensors. The fiducial data can be determined by processing the acquired data from the fiducial target 300 using machine vision techniques as discussed above in relation to FIG. 3 and processing the fiducial data to determine a transform that transforms the fiducial data into the same location in a common coordinate system and thereby create sensor initialization data.

At block 504 the computing device 115 processes the acquired data to determine locations of features corresponding to the fiducial target 300 using machine vision techniques. The feature locations are converted from pixel coordinates relative to each sensor into a common coordinate system based on initial alignment data. The sensors can then be initially calibrated by modifying the transformations that convert pixel locations to six-axis common coordinate locations to cause the common feature on the fiducial targets 300, as defined above in relation to FIG. 3 to assume the same locations in common coordinates.

At block 506 sensor data is acquired for two or more sensors and features determined in sensor data using machine vision techniques acquired by each of the sensors as translated into common coordinates using the initial transforms determined at block 504. The features determined in sensor data can be the locations of objects in an environment around a vehicle 110, including other vehicles and pedestrians, for example.

At block 508 errors are determined by comparing the six-axis locations of features in common coordinates between pairs of sensors.

At block 510 the errors are used to determine six-axis transformations that can be used to calibrate the sensors based on calculating updates to the calibration transformations based on equations (1)-(9), above. This process can be repeated periodically to re-calibrate the two or more sensors periodically as the vehicle 110 is operated on roadways to compensate for mis-calibration of the sensors caused by vibration, shock, or other causes of sensor misalignment that can occur.

At block 512 common coordinate locations of objects including other vehicles and pedestrians can be used to operate the vehicle 110. For example, common coordinate locations of objects can be provided to a computer that autonomously or semi-autonomously operates the vehicle 110, e.g., according to known techniques. For example, vehicle 110 can determine a vehicle path upon which to operate the vehicle 110 which avoids contact or near-contact with the determined objects. Vehicle 110 can operate on the vehicle path by controlling vehicle powertrain, steering, and brakes to cause the vehicle 110 to travel along the path and thereby avoid contact with the determined objects. Following block 512 process 500 ends.

Computing devices such as those discussed herein generally each include commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A computer, comprising:
a processor; and
a memory, the memory storing instructions executable by the processor to:
receive initialization data for vehicle sensors including a first sensor, a second sensor and a third sensor, wherein the first sensor and the second sensor are a same type of sensor, and wherein initialization data is measurement of a common location on a fiducial target;
determine a common coordinate system by a pair-wise evaluation of the initialization data between the first and second sensors;
acquire first, second, and third sensor data from the first, second, and third sensors respectively;
translate first, second, and third sensor data into the common coordinate system;
determine errors in the first, second, and third sensor data based on the common coordinate system;
determine a transformation to correct the errors;
calibrate one or more of the first, second, and third sensors with respect to the common coordinate system based on the determined transformation to remove the errors; and
operate a vehicle based on first, second, and third sensor data acquired by calibrated first, second and third sensors.

2. The computer of claim 1, wherein pair-wise evaluation of initialization data includes comparing the initialization data between one or more of the first and second sensors, the first and third sensors, and the second and third sensors.

3. The computer of claim 1, the instructions further including instructions to determine initialization data based on one or more of a global positioning system (GPS), an inertial measurement unit (IMU) and wheel encoders.

4. The computer of claim 1, the instructions further including instructions to determine the common coordinate system based on acquiring sensor data that includes detecting a fiducial target in each of first and second sensor initialization data.

5. The computer of claim 4, the instructions further including instructions to determine the common coordinate system based on third sensor initialization data by determining a location of fiducial data in the third sensor initialization data.

6. The computer of claim 1, the instruction further including instructions to determine a common feature in the first, second and third sensor data, wherein the common feature is determined by locating an object in an environment around a vehicle with machine vision.

7. The computer of claim 6, the instructions further including instructions to determine the error by comparing the locations of the object in each of the first, second, and third sensor data.

8. The computer of claim 7, the instructions further including instructions to determine the transformation based on minimizing the errors between the locations of the object in first, second, and third sensor data.

9. The computer of claim 1, the instruction further including instruction to update the transformation and re-calibrate the first, second, and third sensors periodically as the vehicle is operated.

10. The computer of claim 1, wherein the transformation includes translations in x, y, and z linear coordinates and rotations in roll, pitch, and yaw angular coordinates.

11. A method, comprising:
receiving initialization data for vehicle sensors including a first sensor, a second sensor and a third sensor, wherein the first sensor and the second sensor are a same type of sensor, and wherein initialization data is measurement of a common location on a fiducial target;
determining a common coordinate system by a pair-wise evaluation of the initialization data between the first and second sensors;
acquiring first, second, and third sensor data from the first, second, and third sensors respectively;
translating first, second, and third sensor data into the common coordinate system;
determining errors in the first, second and third sensor data based on the common coordinate system;
determining a transformation to correct the errors;
calibrating one or more of the first, second, and third sensors with respect to the common coordinate system based on the determined transformation to remove the errors; and
operating a vehicle based on first, second, and third sensor data acquired by calibrated first, second and third sensors.

12. The method of claim 11, wherein pair-wise evaluation of initialization data includes comparing the initialization data between one or more of the first and second sensors, the first and third sensors, and the second and third sensors.

13. The method of claim 11, further comprising determining initialization data based on one or more of a global positioning system (GPS), an inertial measurement unit (IMU), and wheel encoders.

14. The method of claim 11, further comprising determining the common coordinate system based on acquiring sensor data that includes detecting a fiducial target in each of first and second sensor initialization data.

15. The method of claim 14, further comprising determining the common coordinate system based on third sensor initialization data by determining a location of fiducial data in the third sensor initialization data.

16. The method of claim 11, further comprising determining a common feature in the first, second and third sensor data, wherein the common feature is determined by locating an object in an environment around a vehicle with machine vision techniques.

17. The method of claim 16, further comprising determining the error by comparing the locations of the object in each of the first, second, and third sensor data.

18. The method of claim 17, further comprising determining the transformation based on minimizing the errors between the locations of the object in first, second, and third sensor data.

19. The method of claim 11, further comprising updating the transformation and re-calibrate the first, second, and third sensors periodically as the vehicle is operated.

20. The method of claim 11, wherein the transformation includes translations in x, y, and z linear coordinates and rotations in roll, pitch, and yaw angular coordinates.
